(19) United States
(12) Patent Application Publication
(10) Pub. No.: US 2010/0262479 A1
(43) Pub. Date: Oct. 14, 2010

(54) SYSTEM AND METHOD FOR REWARDING COMMENTATORS

(75) Inventor: Michael A. SHARP, Porter, TX (US)

Correspondence Address: Geoffrey B. Rugg, P.O. Box 85, Boulder, CO, 80306, US

(73) Assignee: Bandtones LLC, Gulfport, MS (US)

(21) Appl. No.: 12/507,911

(22) Filed: Jul. 23, 2009

Related U.S. Application Data
(60) Provisional application No. 61/169,155, filed on Apr. 14, 2009.

(51) Int. Cl. G06Q 30/00

(52) U.S. Cl. 705/14.19; 705/14.39; 705/14.7

(57) ABSTRACT

A disclosed method for rewarding a commentator includes enrolling the commentator to create commentary on a computer network. A sponsor is enrolled to distribute a message. The message is incorporated in the commentary created by the commentator. A fee is collected from the sponsor each time the commentary is displayed. At least a portion of the fee is provided to the commentator. The commentary may be a network post, such as a post to a thread, a blog, a newsgroup, or a bulletin board. The message may be an announcement or an advertisement. The commentary may be stored on a network server. A described network server includes a memory storing reward system software, and a processor coupled to the memory to execute the reward system software. A disclosed communication system includes a memory storing embedding software, and a processor coupled to the memory to execute the embedding software.

### CROSS-REFERENCE TO RELATED APPLICATIONS

The present application claims priority to Provisional U.S. Patent Application Ser. No. 61/169,155, entitled “Advertising Systems and Methods to Reward Posters of Content and Comments in Threads, Blogs and Text Messages” and filed on Apr. 14, 2009 by inventor Michael Sharp, incorporated herein by reference in its entirety.

### BACKGROUND

The World Wide Web (“Web”) is a system of interlinked electronic documents accessed via the Internet. A Web log or “blog” is an electronic document maintained by an individual with regular entries of commentary, descriptions of events, or other material such as graphics or video. “Blogging” is the act of maintaining a blog. Blog entries are commonly displayed in reverse-chronological order.

Micro-blogging is a combination of blogging and instant messaging that allows users to create short messages that are posted to their profiles, and may be broadcast to others. Twitter is a social network service that promotes micro-blogging, and allows members to broadcast short messages called “tweets,” containing no more than 140 textual characters, to their subscribers. Micro-blogging via Twitter allows groups of people to stay in frequent contact with each other during the day.

It is now common for people to participate in threaded discussions via the Internet. A “thread” is a set of messages grouped by topic. People participating in a threaded discussion typically submit or “post” comments or messages in series to an electronic document (e.g., a Web page) available to others via the Internet. Internet forums are Web sites at which threaded discussions take place.

Many blog and threaded-discussion publishers allow readers to publicly post comments about the topic of discussion. Comments or messages created by commentators are published, and the commentators become authors, when the comments or messages become parts of electronic documents available to others. Such authors typically do not receive monetary compensation for posting their widely available comments and messages.

There is a need for a system and method for compensating commentators that post comments or messages to electronic documents available to others via the Internet. Viewers of posted comments and messages would benefit as the new source of revenue would allow commentators to spend more time and effort in creating comments and messages.

### SUMMARY

A disclosed method for rewarding a commentator includes enrolling the commentator to create commentary on a computer network. A sponsor is enrolled to distribute a message. The message is incorporated in the commentary created by the commentator. A fee is collected from the sponsor each time the commentary created by the commentator is displayed. At least a portion of the fee is provided to the commentator.

The commentary created by the commentator may be a network post, such as a post to a thread, a blog, a newsgroup, or a bulletin board. The message may be an announcement or an advertisement. The message may be designed to attract attention to a particular store or product. The message may be designed to inspire patronage of a particular store, or purchase of a particular product. The message may be created by the sponsor.

The computer network may be, or include, the Internet. The commentary created by the commentator may be stored on a network server, and may be made available to computer systems connected to the computer network. The collecting of the fee may include deducting the fee from an account of the sponsor each time the commentary created by the commentator is displayed. The providing of at least a portion of the collected fee to the commentator may include depositing at least a portion of the collected fee in an account of the commentator.

A described network server includes a memory storing reward system software, and a processor coupled to the memory to execute the reward system software. The reward system software configures the processor to: enroll a commentator to create commentary on a computer network, enroll a sponsor to distribute a message, deduct a fee from an account of the sponsor each time the commentary created by the commentator is displayed, and deposit at least a portion of the collected fee in an account of the commentator.

A described communication system includes a memory storing embedding software, and a processor coupled to the memory to execute the embedding software. In some embodiments, the embedding software configures the processor to provide commentary, created by a commentator, to a network server so that a message may be embedded in the commentary. In other embodiments, the embedding software configures the processor to embed one or more symbols in commentary created by a commentator, where the one or more symbols cause a message to be retrieved and displayed when an electronic document including the commentary is displayed. The one or more symbols may be or include a meta-tag or java script. The electronic document may be a Web page.

### BRIEF DESCRIPTION OF THE DRAWINGS

FIG. 1 is a diagram of one embodiment of a system that allows commentators (i.e., authors) that post comments or messages to electronic documents available to others via the Internet to be rewarded;

FIG. 2 is a diagram of an illustrative communication system;

FIG. 3 is a diagram of an illustrative server; and

FIG. 4 is a flow chart of one embodiment of a method for rewarding a commentator.

While the disclosed inventions are susceptible to various modifications and alternative forms, specific embodiments thereof are shown by way of example in the drawings and will herein be described in detail. It should be understood, however, that the drawings and detailed description thereto are not intended to limit the inventions to the particular form disclosed, but on the contrary, the intention is to cover all modifications, equivalents and alternatives falling within the spirit and scope of the inventions as defined by the appended claims.

### DETAILED DESCRIPTION

The following detailed description is of the best currently contemplated modes of carrying out the disclosed system and method embodiments. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

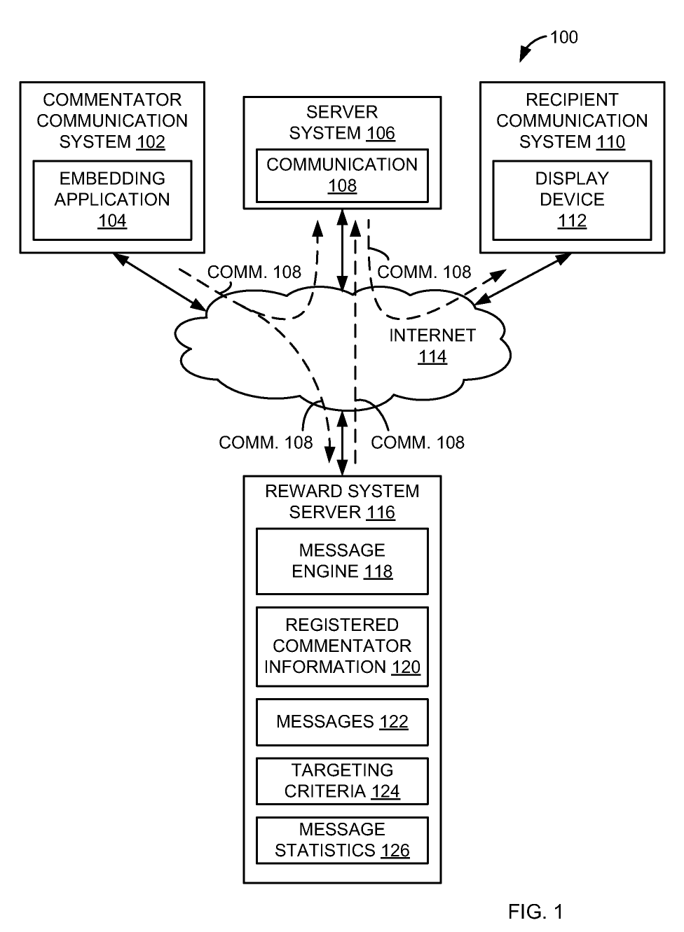

FIG. 1 is a diagram of one embodiment of a system 100 that enables commentators (i.e., authors) that post comments or messages to electronic documents available to others via the Internet to be rewarded. The posted comments or messages (i.e., “commentary”) may become content in, for example, threads, blogs, text messages, and the like. As described in detail below, messages are incorporated in commentaries created by registered commentators. The messages may be, for example, announcements or advertisements, or links to announcements or advertisements. Sponsors pay to have the announcements or advertisements, or links thereto, incorporated in this manner. Viewers of the commentaries created by the registered commentators benefit as this new source of revenue allows commentators to spend more time and effort in generating the commentary.

The system 100 of FIG. 1 includes a commentator communication system 102, a server system 106, a recipient communication system 110, and a reward system server 116, all coupled to the Internet 114. The commentator communication system 102 may be or include, for example, a desktop computer system, a laptop computer system, or a mobile wireless communications device such as a mobile phone. Similarly, the recipient communication system 110 may be or include, for example, a desktop computer system, a laptop computer system, or a mobile wireless communications device such as a mobile phone.

Using the commentator communication system 102, a commentator generates a communication 108. The communication 108 includes text and/or other content such as images or pictures. The communication 108 may be, for example, commentary intended for posting to, for example, a thread, a blog, a micro-blog, a newsgroup, or on a bulletin board. Alternatively, the communication 108 may be an email message, a text message, or an instant message.

As indicated in FIG. 1, the commentator communication system 102 includes an embedding application 104. In the embodiment of FIG. 1, the embedding application 104 either: (i) sends the communication 108 to the reward system server 116 so that a message can be embedded in the communication 108, or (ii) embeds message retrieval information in the communication 108 that causes a message to be retrieved and displayed when an electronic document (e.g., a Web page) including the communication 108 is displayed.

In some embodiments, the embedding application 104 sends the communication 108 generated by the commentator to the reward system server 116. A message engine 118 of the reward system server 116 selects a message to be embedded in the communication 108 from a group of messages 122 stored in the reward system server 116, embeds the selected message in the communication 108, and sends the communication 108 (with the embedded message) to the server system 106.

The message engine 118 preferably uses targeting criteria 124 stored in the reward system server 116 to select the message to be embedded in the communication 108. The server system 106 stores the received communication 108 (with the embedded message). The targeting criteria 124 preferably includes predefined profiling information for each of the messages 122. The profiling information may include, for example, keywords, group, time of day, website URLs, and other information that may indicate where and/or when one of the messages 122 may be displayed.

For example, the message engine 118 may parse the communication 108 and count the number of times words appear in the communication 108. When one or more of the words in the communication 108 are keywords associated with a particular one of the messages 122 in the targeting criteria 124, the message engine 118 may select the particular one of the messages 122 to be embedded in the communication 108.

When a recipient, operating the recipient communication system 110, requests an electronic document (e.g., a Web page) residing on the server system 106 and including the communication 108, the server system 106 responds by sending the electronic document including the communication 108 (with the embedded message) to the recipient communication system 110. When the recipient communication system 110 receives and displays the electronic document, the communication 108 (with the embedded message) is displayed on a display device 112 of the recipient communication system 110. The display device 112 may be, for example, a display screen for displaying visual information, or an audio system for producing audible information. The recipient receives (e.g., views or hears) the communication 108 (with the embedded message) via the display device 112.

In other embodiments, the embedding application 104 embeds message retrieval information in the communication 108 generated by the commentator, and sends the communication 108 (with the embedded message retrieval information) to the server system 106. The message retrieval information may be or include, for example, one or more symbols. The one or more symbols may form a meta-tag or java script that specifies a location where a message resides.

The server system 106 may store the received communication 108 (with the embedded message retrieval information). When the recipient, operating the recipient communication system 110, requests an electronic document (e.g., a Web page) residing on the server system 106 and including the communication 108, the server system 106 may respond by using the message retrieval information to retrieve a corresponding one of the messages 122 from the reward system server 116, and incorporating the message in the communication 108. The server system 106 may then send the electronic document including the communication 108 (with the incorporated message) to the recipient communication system 110. When the recipient communication system 110 receives and displays the electronic document, the communication 108 (with the incorporated message) is displayed on the display device 112. As before, the recipient receives (e.g., views or hears) the communication 108 (with the embedded message) via the display device 112.

The embedding application 104 may be or include, for example, a browser plug-in or a stand-alone software application program. When executed, the embedding application 104 may, for example, provide a window for entering text and selecting a destination. The destination may be, for example, a thread, a blog, a micro-blog, a newsgroup, or a bulletin board. The text may be, for example, a comment regarding a current topic or event.

In the embodiment of FIG. 1, commentators sign up or register with the reward system server 116 to have messages displayed each time they generate a communication 108. The reward system server 116 stores registered commentator information 120, which may include, for example, the commentator's name, mailing address, email address, telephone number, account username and password, and an address of a location to send payments collected from message sponsors supporting the service. The registered commentator information 120 preferably also includes information important to sponsors of messages, such as demographic information, interests, online community memberships, and online community participation statistics. Commentators may generate and maintain the registered commentator information 120 via a standard Web interface, or in cooperation with a reward site employee or consultant.

In the embodiment of FIG. 1, sponsors of messages also sign up or register with the reward system server 116. The sponsors may generate one or more of the messages 122 and/or the targeting criteria 124. Illustrative messages include logos, brand names, mottos, and advertising slogans. The sponsors may generate and maintain information via a standard Web interface, or in cooperation with a reward site employee or consultant.

In the embodiment of FIG. 1, the message engine 118 tracks each registered commentator's posts. Registered sponsors pay a fee each time a message they sponsor is displayed in a post made by a registered commentator. For example, when a registered commentator's message is displayed to a recipient (e.g., via a display device), funds may be transferred from an account of the message sponsor to an account of the registered commentator. The tracking of such payments is carried out by the message engine 118.

Reward system software running on the reward system server 116 may also allow operators of Internet forums (e.g., operating on the server system 106) to sign up or register their forums as either allowing or preventing the use of commentary including sponsored messages in their forums. Examples of Internet forums include online games, bulletin boards, newsgroups, text messaging systems, and social network services. Operators of Internet forums that allow commentary including sponsored messages would benefit as the quality of posted commentary improves.

With regard to online communities, messages can be targeted on the basis of the profiles of registered commentators, the profile of the online community, and/or the type of communication. Some registered commentators may be in more demand than others, enabling them to demand higher rates for including messages. In this manner, registered commentators are compensated for their participation in online communities, and given an incentive to become respected members of those communities. Registered commentators will be able to devote more time to such communities, and the quality of such communities should generally improve. Consequently, the organizers of online communities may be expected to be receptive to the inclusion of messages.

In the embodiment of FIG. 1, the message engine 118 also gathers and stores message statistics 126, which may include, for example, a number of times and locations (e.g., URLs) where particular messages are displayed. The message statistics 126 for a particular message may be provided to the corresponding registered sponsor.

In some embodiments, one or more of the messages 122 stored in the reward system server 116 may be, or include, telephone numbers or links to audio messages. For example, the audio messages may be generated via a telephony server coupled to both the public switched telephone network (PSTN) and the Internet 114, and including a phone recorder for recording audio messages. For example, the reward system server 116 may be such a telephony server. When a registered commentator dials a particular telephone number assigned to the telephony server, the telephony server answers the call and records an audio message generated by the registered commentator. The telephony server then stores the audio message and assigns a second telephone number to the recorded audio message.

The second telephone number is then included in the message. For example, the telephony server (e.g., the reward system server 116) may provide the second telephone number to the embedding application 104, and the embedding application 104 may include the second telephone number in the message. The message (including the second telephone number) may be incorporated in the communication 108 as described above. When a recipient views the communication 108 and calls the second telephone number, the telephony server (e.g., the reward system server 116) answers the call and plays back the recorded audio message.

Here is an example of a message that includes both text and a phone number: “Super Brite Toothpaste Your Smile is Your Fortune—+1 (641) 453-0117.” The message includes the telephone number “+1 (641) 453-0117” that corresponds to an audio message. The telephone number “+1 (641) 453-0117” is expressed in an international format. The format of an international telephone number is: international prefix+country code+area code+telephone number. The “+” before the country code denotes an international prefix that may need to be dialed by a caller. For example, as the country code is “1,” a caller in the United States need not dial an international prefix. On the other hand, a caller in the United Kingdom must dial the international prefix “00” to reach the United States. When a recipient views a communication 108 including the above message and calls the telephone number “+1 (641) 453-0117,” the telephony server answers the call and plays back the corresponding recorded audio message.

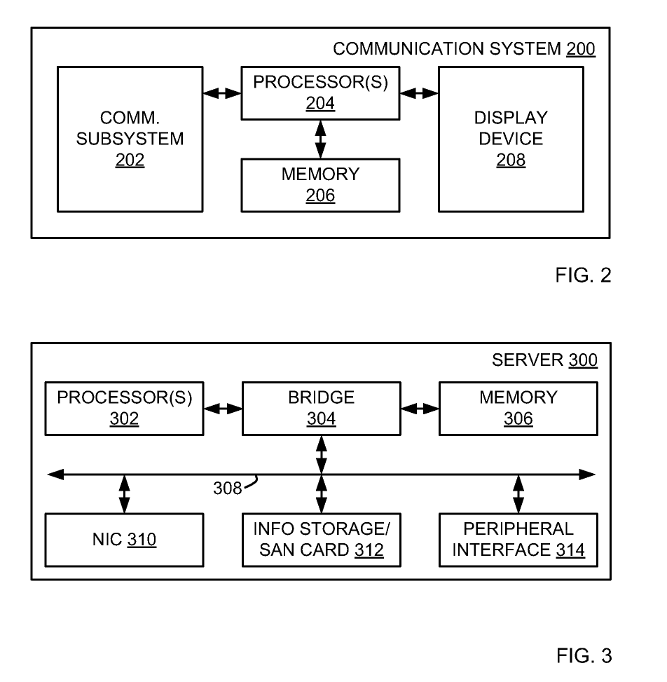

FIG. 2 is a diagram of an illustrative communication system 200. The commentator communication system 102 of FIG. 1 and the recipient communication system 110 of FIG. 1 may include some or all of the components of the illustrative communication system 200. In the embodiment of FIG. 2, the communication system 200 includes a communication subsystem 202, one or more processors 204 coupled to the communication subsystem 202, a memory 206 coupled to the processor(s) 204, and a display device 208 coupled to the processor(s) 204.

In the embodiment of FIG. 2, the communication subsystem 202 is adapted for coupling to the Internet 114 of FIG. 1, and allows the illustrative communication system 200 to communicate with other devices via the Internet 114. The communication subsystem 202 may include, for example, a network interface card (NIC), or a wireless network interface card (WNIC). The memory 206 stores software instructions, and includes nonvolatile memory. For example, the memory 206 may include hard disc drive storing the software instructions. The memory 206 may also include volatile memory. The display device 208 may be or include, for example, a display screen for displaying visual information and/or an audio system for producing audible information. The processor(s) 204 control the communication subsystem 202 and the display device 208. During operation of the communication system 200, the processor(s) 204 fetch software instructions from the memory 206, and execute the instructions.

In some embodiments of the commentator communication system 102 of FIG. 1, the software instructions stored in the memory 206 include software instructions of the embedding application 104. As the processor(s) 204 execute the software instructions of the embedding application 104, the processor(s) 204 are configured to provide commentary (e.g., the communication 108), created by a commentator, to a network server (e.g., the reward system server 116) so that a message may be embedded in the commentary. In other embodiments, as the processor(s) 204 execute the software instructions of the embedding application 104, the processor(s) 204 are configured to embed message retrieval information (e.g., one or more symbols) in the commentary, where the message retrieval information causes a message to be retrieved and displayed when an electronic document including the commentary is displayed.

FIG. 3 is a diagram of an illustrative server 300. The server system 106 of FIG. 1 and the reward system server 116 of FIG. 1 may include some or all of the components of the illustrative server 300. In the embodiment of FIG. 3, the server 300 includes one or more processors 302, a memory 306, and a high-speed bridge 304 that connects the processor(s) 302 with the memory 306 and an expansion bus 308. The expansion bus 308 supports communication with a network interface card (NIC) 310, an information storage device 312, and a peripheral interface 3 14.

In the embodiment of FIG. 2, the NIC 310 is coupled to the Internet 114, and allows the illustrative server 300 of communicate with other devices coupled to the Internet 114. The information storage device 312 typically includes a nonvolatile memory for firmware and/or a hard disc drive storing software instructions and data. On distributed systems with high data availability requirements, the information storage device 312 may be replaced or supplemented with a storage area network (SAN) card that enables shared access to a large disk array. The peripheral interface 314 provides ports for communicating with external devices such as keyboard, mice, universal serial bus (USB) devices, printers, cameras, audio systems, etc. On many servers, these ports may be left largely unused, but they are available for configuration, diagnostic, performance monitoring purposes.

During initial operation of the illustrative server 300, the processor(s) 302 loads the software instructions from the information storage device 312 into the memory 306, either all at once or on an “as needed” basis (e.g., by paging the needed instructions into memory). During operation of the server 300, the processor(s) 302 fetch the software instructions from the memory 306, and execute the software instructions.

In some embodiments of the reward system server 116 of FIG. 1, the information storage device 312 stores software instructions and data of reward system software. As the processor(s) 302 fetch and execute the software instructions of the reward system software, the instructions of the reward system software configure the processor(s) 302 to enroll a commentator to create commentary on a computer network, to enroll a sponsor to distribute a message, to deduct a fee from an account of the sponsor each time the commentary created by the commentator is displayed, and to deposit at least a portion of the collected fee in an account of the commentator.

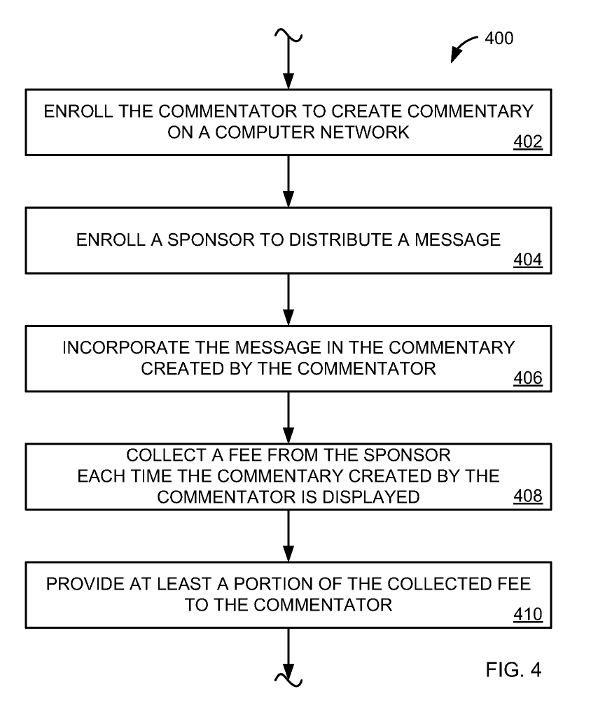

FIG. 4 is a flow chart of one embodiment of a method 400 for rewarding a commentator. In the embodiment of FIG. 4, a step 402 of the method 400 includes enrolling the commentator to create commentary on a computer network. The computer network may be, or include, the Internet. The commentary created by the commentator may be stored on a network server (e.g., the server system 106 of FIG. 1), and may be made available to computer systems connected to the computer network. The commentary created by the commentator may be a network post, such as a post to a thread, a blog, a newsgroup, or a bulletin board.

A sponsor is enrolled to distribute a message during a step 404. The message may be, for example, an announcement or an advertisement. The message may be designed to attract attention to a particular store or product. For example, the message may be designed to inspire patronage of a particular store, or purchase of a particular product. The message may be created by the sponsor.

During a step 406, the message is incorporated in the commentary created by the commentator. A step 408 includes collecting a fee from the sponsor each time the commentary created by the commentator is displayed. At least a portion of the collected fee is provided to the commentator during a step 410. The collecting of the fee may include deducting the fee from an account of the sponsor each time the commentary created by the commentator is displayed. The providing of at least a portion of the collected fee to the commentator may include depositing at least a portion of the collected fee in an account of the commentator.

I claim:

1. A method for rewarding a commentator, comprising:
enrolling the commentator to create commentary on a computer network;
enrolling a sponsor to distribute a message;
incorporating the message in the commentary created by the commentator;
collecting a fee from the sponsor each time the commentary created by the commentator is displayed; and
providing at least a portion of the collected fee to the commentator.

2. The method as recited in claim 1, wherein the commentary created by the commentator comprises a network post.

3. The communication system as recited in claim 1, wherein the commentary is a post to a thread, a blog, a newsgroup, or a bulletin board.

4. The method as recited in claim 1, wherein the message is designed to attract attention to a particular store or product.

5. The method as recited in claim 1, wherein the message is designed to inspire patronage of a particular store, or purchase of a particular product.

6. The method as recited in claim 1, wherein the message is an advertisement.

7. The method as recited in claim 1, wherein the message is an announcement.

8. The method as recited in claim 1, wherein the message is created by the sponsor.

9. The method as recited in claim 1, wherein the commentary created by the commentator is stored on a network server, and is made available to computer systems connected to the computer network.

10. The method as recited in claim 1, wherein the computer network comprises the Internet.

11. The method as recited in claim 1, wherein the collecting of the fee comprises deducting the fee from an account of the sponsor each time the commentary created by the commentator is displayed, and wherein the providing of at least a portion of the collected fee to the commentator comprises depositing at least a portion of the collected fee in an account of the commentator.

12. A network server, comprising:
a memory that stores reward system software;
a processor coupled to the memory to execute the reward system software;
wherein the reward system software configures the processor to:
enroll a commentator to create commentary on a computer network;
enroll a sponsor to distribute a message;
deduct a fee from an account of the sponsor each time the commentary created by the commentator is displayed; and
deposit at least a portion of the collected fee in an account of the commentator.

13. The communication system as recited in claim 12, wherein the commentary is a post to a thread, a blog, a newsgroup, or a bulletin board.

14. The communication system as recited in claim 12, wherein the message is an advertisement or an announcement.

15. A communication system, comprising:
a memory that stores embedding software;
a processor coupled to the memory to execute the embedding software; and
wherein the embedding software configures the processor to provide commentary, created by a commentator, to a network server so that a message may be embedded in the commentary.

16. The communication system as recited in claim 15, wherein the commentary is a post to a thread, a blog, a newsgroup, or a bulletin board.

17. The communication system as recited in claim 15, wherein the message is an advertisement or an announcement.

18. A communication system, comprising:
a memory that stores embedding software;
a processor coupled to the memory to execute the embedding software; and
wherein the embedding software configures the processor to embed one or more symbols in commentary created by a commentator, and wherein the one or more symbols cause a message to be retrieved and displayed when an electronic document including the commentary is displayed.

19. The communication system as recited in claim 18, wherein the one or more symbols comprise a meta-tag or java script.

20. The communication system as recited in claim 18, wherein the electronic document is a Web page.
